(19) United States
(12) Patent Application Publication
(10) Pub. No.: US 2022/0380645 A1
(43) Pub. Date: Dec. 1, 2022

(54) HIGH CREEP RECOVERY, LOW MODULUS POLYMER SYSTEMS AND METHODS OF MAKING THEM

(71) Applicant: Henkel AG & Co. KGaA, Duesseldorf (DE)

(72) Inventors: Puwei Liu, Glastonbury, CT (US); Nicolas Ball Jones, Walnut Creek, CA (US); Mark Jason, Longmeadow, MA (US); Zhan Hang Yang, Rocky Hill, CT (US)

(21) Appl. No.: 17/874,870

(22) Filed: Jul. 27, 2022

Related U.S. Application Data
(63) Continuation of application No. PCT/US2021/015085, filed on Jan. 26, 2021.
(60) Provisional application No. 62/966,221, filed on Jan. 27, 2020.

(51) Int. Cl. C09J 175/08

(52) U.S. Cl. CPC C09J 175/08

(57) ABSTRACT

Disclosed herein are methods of making an adhesive composition, the methods comprising providing a polyurethane acrylate and combining with a vinyl ether and co-curing the combination to form an adhesive composition, wherein after curing the adhesive composition has a modulus at −20° C. of less than about 10.0 mPa and a creep recovery of greater than about 50%. Also disclosed are the resulting adhesive compositions.

### BACKGROUND

Electronic devices that display images, such as smart phones, digital cameras, notebook computers, navigation units, and televisions, include display panels for displaying images. Thin and lightweight flat display panels are widely used for image display. Many types of flat display panels exist, including liquid crystal display (LCD) panels, organic light-emitting diode (OLED) display panels, plasma display panels (PDPs), electrophoretic display (EPD) panels, and the like.

Flexible electronic displays or foldable displays, which can be folded for portability and unfolded to increase the viewing area, are being developed. Flexible electronic displays, where the display can be bent freely without cracking or breaking, is a rapidly emerging technology area for making electronic devices using, for example, flexible plastic substrates.

With the emergence of these flexible electronic displays, there is an increasing demand for adhesives, and particularly for optically clear adhesives (OCA), to serve as an assembly layer or gap filling layer between an outer cover lens or sheet (based on glass, PET, PC, PMMA, polyimide, PEN, cyclic olefin copolymer, etc.) and an underlying display module of electronic display assemblies. The presence of the OCA improves the performance of the display by increasing brightness and contrast, while also providing structural support to the assembly. In a flexible assembly, the OCA will also serve as the assembly layer, which in addition to the typical OCA functions, may also absorb most of the folding induced stress to prevent damage to the fragile components of the display panel and protect the electronic components from breaking under the stress of folding. The OCA layer may also be used to position and retain the neutral bending axis at or at least near the fragile components of the display, such as for example the barrier layers, the driving electrodes, or the thin film transistors of an organic light emitting display (OLED).

Typical OCAs are visco-elastic in nature and are meant to provide durability under a range of environmental exposure conditions and high frequency loading. In such cases, a high level of adhesion and some balance of visco-elastic property is maintained to achieve good pressure-sensitive behavior and incorporate damping properties in the OCA. However, these properties are not fully sufficient to enable foldable or durable displays.

A foldable display for OLED devices requires highly bendable optical adhesives to bond plastic substrates together. A normal folding test requires an adhesive to pass 100,000 cycles of radius 1 mm (180 degree bending) folding through a temperature range of −20° C. to 85° C. There are no commercial products that meet this test. A foldable adhesive should have a high recovery speed and a low residual strain for good foldability.

Two important properties in an OCA used in a foldable display device are modulus and creep recovery rate. When a device is folded, the folding generates shear stress between the adhesive and the substrates at the ends of the device while and compression in the bent area in the middle of the device. When the device returns to a flat state, stresses in these areas are released.

Especially for adhesives used in foldable displays, it is highly desirable to have a polymer system that exhibits a very low modulus (especially at a low temperatures) and a high creep recovery rate. These two physical properties typically oppose each other. Polymer structures that exhibit high creep recovery typically have a high modulus, while those that exhibit a low modulus have low creep recovery. For example, known high creep recovery polymers require a highly crosslinked network with high elasticity, which generally has a relatively high modulus, especially at low temperatures.

Accordingly, there remains a need for a polymer that exhibits a combination of low modulus and high creep recovery rate.

### SUMMARY

Disclosed herein is a new co-cured polyacrylate/vinyl ether adhesive polymer that exhibits very low modulus at −20° C. (less than 10.0 mPa) and exhibits excellent creep recovery (greater than 50%). The adhesive polymer composition achieves a combination of low modulus and high creep recovery, in particular a creep recovery from >70% to >90% and a modulus at −20° C. from <1.0 mPa to <0.3 mPa.

Also disclosed herein is a method of making an adhesive composition comprising co-curing a polyurethane acrylate and a vinyl ether to form the adhesive composition, wherein after curing the adhesive composition has a modulus at −20° C. of less than about 10.0 mPa and a creep recovery of greater than about 50%.

### DETAILED DESCRIPTION

Disclosed herein is a new co-cured polyacrylate/vinyl ether adhesive polymer composition that exhibits very low modulus at −20° C. (less than 10.0 mPa) and exhibits excellent creep recovery (greater than 50%). The polymer composition produced by this method achieves a combination of low modulus and high creep recovery, in particular a creep recovery from >70% to >90% and a modulus at −20° C. from <1.0 mPa to <0.3 mPa.

Also disclosed herein is a method of making an adhesive composition comprising co-curing a polyurethane acrylate and a vinyl ether resin to form the adhesive composition, wherein after curing the adhesive composition has a modulus at −20° C. of less than about 10.0 mPa and a creep recovery of greater than about 50%. The polymer composition achieves a combination of low modulus and high creep recovery, in particular a creep recovery from >70% to >90% and a modulus at −20° C. from <1.0 mPa to <0.3 mPa.

The polyurethane acrylate utilized herein may be made by the reacting a highly branched diol with a diisocyanate to obtain a polyurethane and reacting the polyurethane with an acrylate to form the polyurethane acrylate, as described in more detail below.

The resulting polyurethane acrylate/vinyl ether adhesive composition exhibits very low modulus at −20° C. and exhibits excellent creep recovery. Particularly, the creep recovery can be greater than about 70%, for example greater than about 90% while the modulus at −20° C. can be less than about 4.0 mPa, for example less than about 1.0 mPa, and even less than about 0.3 mPa.

In addition to the polyurethane acrylate and the vinyl ether, the adhesive composition may also include other ingredients.

Suitable polyurethane acrylates for use in the present invention include the following:

| Polymer | Tg (° C.) |
|---|---|
| Poly(2-ethylhexyl acrylate) | −53 |
| Poly(2,2,3,3-tetrafluoropropyl acrylate) | −24 |
| Poly(4-cyanobutyl acrylate) | −38 |
| Poly(butyl acrylate) | −53 |
| Poly(dodecyl acrylate) | −19 |
| Poly(ethyl acrylate) | −23 |
| Poly(hexyl acrylate) | −59 |
| Poly(isobutyl acrylate) | −34 |
| Poly(isopropyl acrylate) | −2 |
| Poly(nonyl acrylate) | −74 |
| Poly(propyl acrylate) | −42 |
| Poly(sec-butyl acrylate) | −21 |
| Poly(tetrahydro furfuryl acrylate) | −14 |

| Polymer | Tg (° C.) |
|---|---|
| Poly(decyl methacrylate) | −63 |
| Poly(dodecyl methacrylate) | −55 |
| Poly(hexyl methacrylate) | −5 |
| Poly(isodecyl methacrylate) | −41 |
| Poly(octyl methacrylate) | −45 |

Vinyl ethers useful in the present invention include the following:

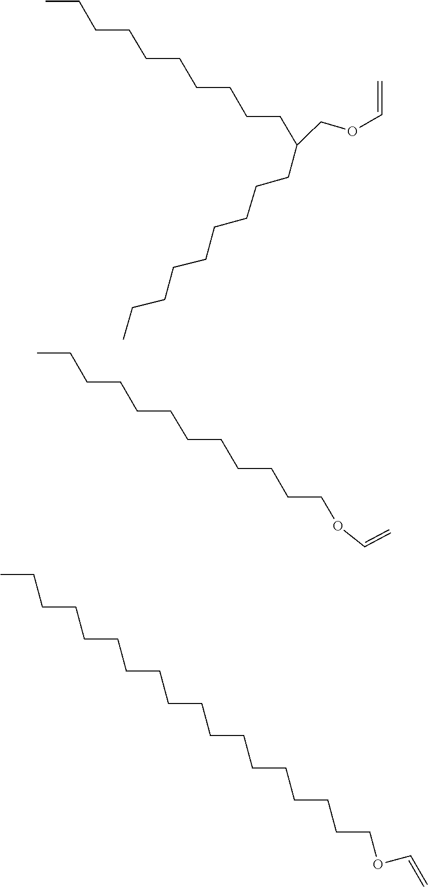

| Polymer | Tg (° C.) |
|---|---|
| Poly(butyl vinyl ether) | −54 |
| Poly(ethyl vinyl ether) | −41 |
| Poly(hexyl vinyl ether) | −76 |
| Poly(isobutyl vinyl ether) | −19 |
| Poly(isopropyl vinyl ether) | −3 |
| Poly(methyl vinyl ether) | −28 |
| Poly(octyl vinyl ether) | −80 |
| Poly(propyl vinyl ether) | −49 |

The adhesive polymer formed by co-curing a polyurethane acrylate and vinyl ether surprisingly possesses extremely high creep recovery combined with a very low modulus. Applicant has found that introducing a vinyl ether monomer into an acrylate polymer system can significantly reduce the modulus and Tg of the resulting polymer while also yielding a very high creep recovery at very low modulus. This combination of physical properties of very low modulus at low temperature with very high creep recovery has not previously been exhibited in polymer adhesive systems and is an unexpected beneficial result.

In one embodiment, the method of making an adhesive composition comprises combining a polyurethane acrylate and a vinyl ether to form a mixture and co-curing the mixture to form the adhesive composition, wherein after curing the adhesive composition has a modulus of less than about 10.0 mPa at −20° C. and a creep recovery of greater than about 50%.

In another embodiment, the polyurethane acrylate used in the method is created by providing a highly branched diol; reacting the highly branched diol with a diisocyanate to obtain a polyurethane; and reacting the polyurethane with an acrylic group to form a polyurethane acrylate. The diol may have a molecular weight of greater than about 1000 g/mol.

In another embodiment, the co-curing is done by light curing or heat curing.

In another embodiment, the diisocyanate is an aliphatic diisocyanate.

In another embodiment, the polyurethane acrylate is combined with vinyl ether in a molar ratio of vinyl ether to polyurethane acrylate of equal to or less than about 1.

In another embodiment, the polyurethane acrylate has a molecular weight of over about 25000 g/mol.

In another embodiment, the adhesive composition has a modulus of less than about 1.0 mPa at −20° C. and a creep recovery of greater than about 70%.

In another embodiment, the adhesive composition has a modulus or less than about 0.3 mPa at −20° C. and a creep recovery of greater than about 90%.

In another embodiment, the polyurethane acrylate has a glass transition temperature of less than 10° C.

In another embodiment, the polyurethane acrylic polymer has a glass transition temperature of less than −30° C.

In another embodiment, the polyurethane acrylic polymer is combined with a photoinitiator or a thermal initiator before the co-curing step.

In another embodiment, the vinyl ether may be selected from poly(butyl vinyl ether), poly(ethyl vinyl ether), poly(hexyl vinyl ether), poly(isobutyl vinyl ether), poly(isopropyl vinyl ether), poly(methyl vinyl ether), poly(octyl vinyl ether), poly(propyl vinyl ether), and combinations thereof.

In another embodiment, the polyurethane acrylate may be selected from poly(2-ethylhexyl acrylate), poly(2,2,3,3,-tetrafluoropropyl acrylate), poly(4-cyanobutyl acrylate), poly(butyl acrylate), poly(dodecyl acrylate), poly(ethyl acrylate), poly(hexyl acrylate), poly(isobutyl acrylate), poly (isopropyl acrylate), poly (nonyl acrylate), poly(propyl acrylate), poly(sec-butyl acrylate), poly (tetrahydrofurfural acrylate), poly decyl methacrylate), poly(dodecyl methacrylate), poly(hexyl methacrylate), poly(isodecyl methacrylate), poly(octyl methacrylate), and combinations thereof.

The disclosure also provides an adhesive composition comprising: a co-cured mixture of polyurethane acrylate and vinyl ether, wherein the adhesive composition has a modulus of less than about 10.0 mPa at −20° C. and a creep recovery of greater than about 50%.

In one embodiment, the adhesive composition has a modulus of less than about 1.0 mPa at −20° C. and a creep recovery of greater than about 70%.

In one embodiment, the adhesive composition has a modulus of less than about 0.3 mPa at −20° C. and a creep recovery of greater than about 90%.

In another embodiment, the molar ratio of the vinyl ether to the acrylic monomer is less than about 1.

In another embodiment, there is no solvent present in the composition.

In another embodiment, the composition further comprises a thermal initiator or a photoinitiator.

In another embodiment, the diol used to prepare the polyurethane acrylate used in the invention has a highly branched polymer backbone as exemplified below:

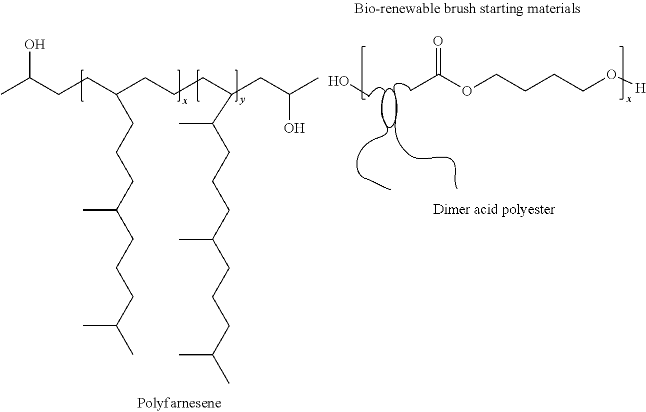

### Synthesis of Polyurethane Acrylates

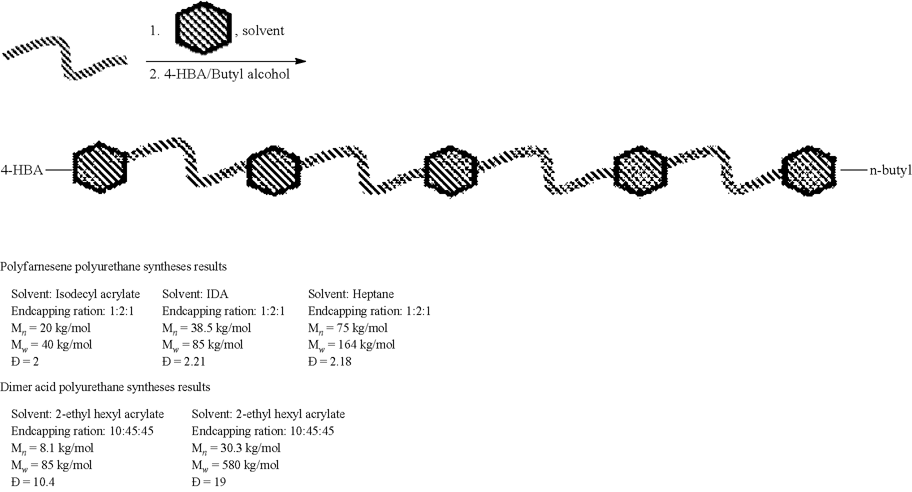

(NBJ408535) A 3000 g/mol dihydroxylated polyfarnesene (CVX50452, 40 g, 0.0133 mol) was added to a 100 mL reactor equipped with an overhead stirrer that was heated to 80 C. Isodecyl acrylate (18.8 g, 0.0887 mol) was added, followed by dibutyltin dilaurate (0.03 g, 0.0001 mol) and irganox 1010 (0.03 g). Subsequently IPDI (3.46 g, 0.0156 mol) was added in two portions (95% in first shot). The reaction was monitored by infrared spectroscopy, and the persistence of the isocyanate peak (ca. 2200 cm-1) was confirmed before addition of hydroxyl quenching agent. 4-hydroxybutyl acrylate (0.11 g, 0.0008 mol) was added after the isocyanate concentration stabilized as observed by infrared spectroscopy. After an hour butanol (0.06 g, 0.0008 mol) was added to finish quenching the reaction. Infrared spectroscopy was used to confirm the complete conversion of isocyanate. The results of the synthesis were as follows: Mn=19.9 kg/mol, Mw=39.9 kg/mol, Ð=2.

(NBJ408536) A 3000 g/mol dihydroxylated polyfarnesene (CVX50452, 100 g) was added to a 1.5 L reactor equipped with an overhead stirrer that was heated to 80 C. Heptane (133 g) was added, followed by dibutyltin dilaurate (0.07 g). Subsequently IPDI (8.165) was added in two portions (93% in first shot). The reaction was monitored by infrared spectroscopy, and the persistence of the isocyanate peak (ca. 2200 cm-1) was confirmed before addition of hydroxyl quenching agent. 4-hydroxybutyl acrylate (0.2 g) and butanol (0.11 g) were added together, after the isocyanate concentration stabilized as observed by infrared spectroscopy. Infrared spectroscopy was used to confirm the complete conversion of isocyanate. The results of the synthesis were as follows: Mn=75.2 kg/mol, Mw=164.0 kg/mol, Ð=2.18.

(NBJ408537) A 3000 g/mol dihydroxylated polyfarnesene (CVX50452, 152 g) was added to a 1.5 L reactor equipped with an overhead stirrer that was heated to 80 C. Isodecyl acrylate (65 g) was added, followed by dibutyltin dilaurate (0.106 g) and Irganox 1010 (0.106 g). Subsequently IPDI (12.90948 g) was added in two portions (92% in first shot). The reaction was monitored by infrared spectroscopy, and the persistence of the isocyanate peak (ca. 2200 cm-1) was confirmed before addition of hydroxyl quenching agent. 4-hydroxybutyl acrylate (0.617 g) and butanol (0.317 g) were added together, after the isocyanate concentration stabilized as observed by infrared spectroscopy. This combination was targeted to get a statistical 25:50:25 ratio of di:mono:non-functional polymer chains. Infrared spectroscopy was used to confirm the complete conversion of isocyanate. The results of the synthesis were as follows: Mn=40.9 kg/mol, Mw=156.7 kg/mol, Ð=3.82.

(NBJ408541) A 3000 g/mol dihydroxylated polyol (Priplast 3196—Croda, 155.5 g) was added to a 1.5 L reactor equipped with an overhead stirrer that was heated to 80 C. 2-ethylhexyl acrylate (66.6 g) was added, followed by dibutyltin dilaurate (0.108 g) and Irganox 1010 (0.108 g). Subsequently IPDI (12.844 g) was added in two portions (92% in first shot). The reaction was monitored by infrared spectroscopy, and the persistence of the isocyanate peak (ca. 2200 cm-1) was confirmed before addition of hydroxyl quenching agent. 4-hydroxybutyl acrylate (1.98 g) and butanol (2.04 g) were added together, after the isocyanate concentration stabilized as observed by infrared spectroscopy. This combination was targeted to get a statistical 10:45:45 ratio of di-:mono-:non-functional polymer chains. Infrared spectroscopy was used to confirm the complete conversion of isocyanate. The results of the synthesis were as follows: Mn=8.1 kg/mol, Mw=85 kg/mol, Ð=10.4.

(NBJ408544) A 3000 g/mol dihydroxylated polyol (Priplast 3196—Croda, 305.88 g) was added to a 1.5 L reactor equipped with an overhead stirrer that was heated to 80 C. 2-ethylhexyl acrylate (131.1 g) was added, followed by dibutyltin dilaurate (0.214 g) and Irganox 1010 (0.214 g). Subsequently IPDI (25.69 g) was added in two portions (92% in first shot). The reaction was monitored by infrared spectroscopy, and the persistence of the isocyanate peak (ca. 2200 cm-1) was confirmed before addition of hydroxyl quenching agent. 4-hydroxybutyl acrylate (1.05 g) and butanol (1.08 g) were added together, after the isocyanate concentration stabilized as observed by infrared spectroscopy. This combination was targeted to get a statistical 10:45:45 ratio of di-:mono-:non-functional polymer chains. Infrared spectroscopy was used to confirm the complete conversion of isocyanate. The results of the synthesis were as follows: Mn=30.3 kg/mol, Mw=580 kg/mol, Ð=19.1.

(NBJ408546) A 3000 g/mol dihydroxylated polyol (Priplast 3196—Croda, 217.76 g) was added to a 1.5 L reactor equipped with an overhead stirrer that was heated to 80 C. 2-ethylhexyl acrylate (93.3 g) was added, followed by dibutyltin dilaurate (0.152 g) and Irganox 1010 (0.152 g). Subsequently IPDI (18.29 g) was added in two portions (92% in first shot). The reaction was monitored by infrared spectroscopy, and the persistence of the isocyanate peak (ca. 2200 cm-1) was confirmed before addition of hydroxyl quenching agent. 4-hydroxybutyl acrylate (2.72 g) was added, after the isocyanate concentration stabilized as observed by infrared spectroscopy. This combination was targeted to get a statistical 100:0:0 ratio of di-:mono-:non-functional polymer chains. Infrared spectroscopy was used to confirm the complete conversion of isocyanate. The results of the synthesis were as follows: Mn=22.8 kg/mol, Mw=111.2 kg/mol, Ð=4.87.

(NBJ408550) A 3000 g/mol dihydroxylated polyol (Priplast 3196—Croda, 176.1 g) was added to a 1.5 L reactor equipped with an overhead stirrer that was heated to 80 C. 2-ethylhexyl acrylate (75.47 g) was added, followed by dibutyltin dilaurate (0.123 g) and Irganox 1010 (0.123 g). Subsequently IPDI (14.794 g) was added in two portions (92% in first shot). The reaction was monitored by infrared spectroscopy, and the persistence of the isocyanate peak (ca. 2200 cm-1) was confirmed before addition of hydroxyl quenching agent. 1,4-butanediol vinyl ether (2.72 g) and butanol (0.557) were added together, after the isocyanate concentration stabilized as observed by infrared spectroscopy. This combination was targeted to get a statistical 25:50:25 ratio of di-:mono-:non-functional polymer chains. Infrared spectroscopy was used to confirm the complete conversion of isocyanate. The results of the synthesis were as follows: Mn=25.5 kg/mol, Mw=131.3 kg/mol, Ð=5.14.

(NBJ408553) A 5000 g/mol polyfarnesene mono-ol (CVX50457, 105 g) was added to a 1.5 L reactor equipped with an overhead stirrer that was heated to 80 C. Dibutyltin dilaurate (0.073 g) and Irganox 1010 (0.073 g) were added. Subsequently AOI (3.33 g) was added in one portion. The reaction was monitored by infrared spectroscopy, and the disappearance of the isocyanate peak (ca. 2200 cm-1) was confirmed to yield fully monofunctional material.

Another set of polymers was designed and synthesized by the similar methodology.

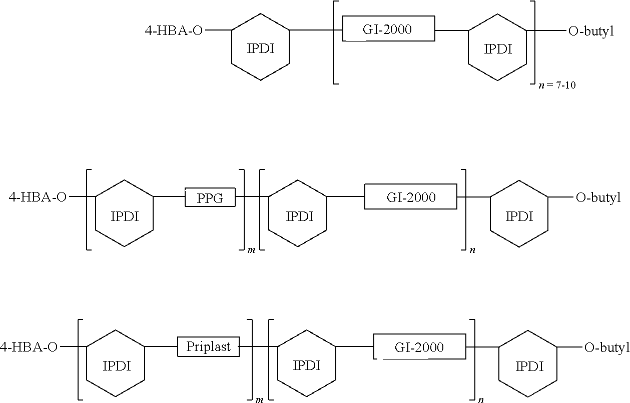

By adjusting the feed ratio of end-cap group, a statistical mono-functional polymer can be made, as described below. In the above depiction, GI-2000IPDIn=7-10O-butyl4-HBA-OGI-2000n4-HBA-OPPGO-butylmGI-2000n4-HBA-OPriplastO-butylmIPDIIPDIIPDIIPDIIPDIIPDIIPDI.

MJ408666G GI2000 blended with PPG with 0.33 HBA end functionality.

MJ408657D GI2000 blended with PPG with 0.50 HBA end functionality.

MJ408650E GI2000 blended with PPG2000 with 0.50 HBA end functionality.

MJ408619F GI2000 blended with PPG with 0.33 end functionality.

MJ408690F GI2000 with 0.5 4-hydroxy butyl vinyl ether end functionality.

MJ408642D GI2000 with 0.5 HBA end functionality.

These resins were synthesized by the procedure described above, using the appropriate starting materials.

The following abbreviations are used herein: 4-HBA—4-hydroxybenzoic acid; IDA—iminodiacetic acid; IPDI—isophorone diisocyanate; IBA—isobornyl acrylate; AOI; 2-BCA; VE—vinyl ester; 2-EHA—2-ethylhexyl acrylate; 2-EH VA; 2-EHVE—2-ethylhexyl vinyl ether; 4-HBVE—4-hydroxybutyl vinyl ether. Irganox 1010 is the trade name for pentaerythritol tetrakis(3-(3,5-di-tert-butyl-4-hydroxyphenyl)propionate).

### Synthesis of 2-decyl-1-tetradecanol acrylate

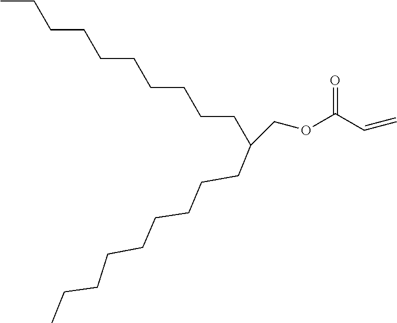 [SMILES: C=CC(=O)OCC(CCCCCCCCC)CCCCCCCCCC]

This acrylate was synthesized by reacting 2-decyl-1-tetradecanol 100.0 g (0.281 mol) with acryloyl chloride 33.38 g (0.369 mol) in toluene, using triethylamine as catalyst. The product is a colorless low viscosity liquid.

### Synthesis of High MW Polymers

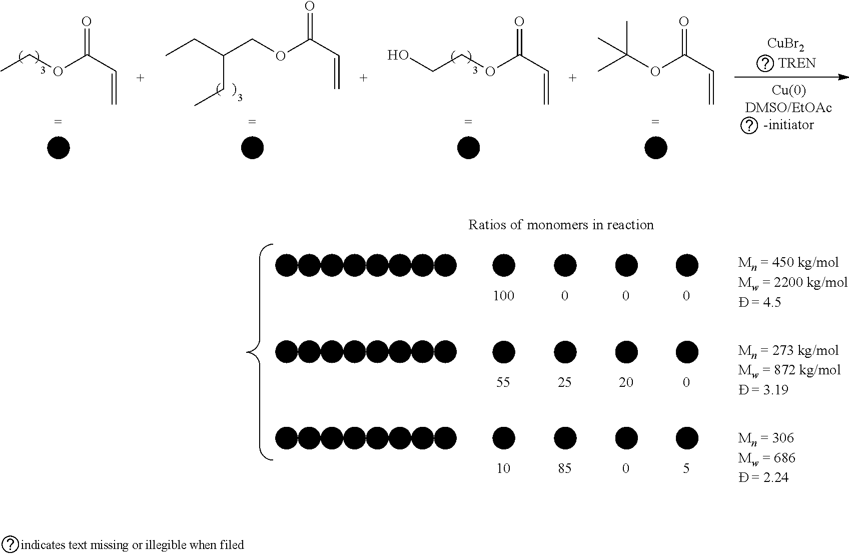

The synthesis of ultrahigh MW polyacrylate was done by a known synthetic procedure of SET-LRP, described as follow:

To a 250 ml four neck round bottom flask, with mechanical stirrer, condenser, additional funnel and rubber septum, was added acetonitrile (13 g), t-butyl acrylate (12.80 g, 100 mmol), copper mesh (0.43 g) (treated with 0.1 N hydrochloric acid aqueous solution for, risen with acetone), copper (II) bromide (0.013 g, 0.05 mmol, or using CuBr₂ stock solution in CH₃CN), the mixture was purged with nitrogen for 30 min, then raised to temperature ˜45° C., to the above solution was injected initiator tert-Butyl α-bromoisobutyrate (1.115 g, 5 mmol) and ligand Me₆TREN (0.12 g, 0.50 mmol, or using stock solution in CH₃CN) via air tight syringes, the reaction was monitored with ¹H NMR until the conversion of t-butyl acrylate >85% (˜2 hrs.) and GPC.

Following the above process but using the appropriate starting materials, the following were prepared.

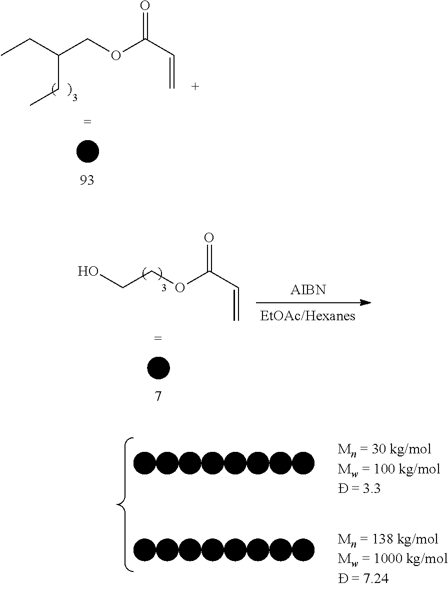

Synthesis of tert-polymer of methacrylate acrylate n-butyl acrylate and t-butyl acrylate (NBJ408529).

The synthesis procedure was described with the feed ratio of:

| | MW | grams | Moles | Mole Ratio | wt % |
|---|---|---|---|---|---|
| methyl acrylate | 86.09 | 0.00 | 0.0000 | 0.0 | 0.00% |
| tert-butyl acrylate | 128.17 | 0.00 | 0.0000 | 0.0 | 0.00% |
| n-butyl acrylate | 128.17 | 615.22 | 4.8000 | 8000.0 | 57.35% |
| Dimethyl sulfoxide | 78.13 | 336.1 | | | 31.33% |
| Ethyl Acetate | 88.11 | 121.2 | | | 11.30% |
| Copper (II) Bromide | 223.37 | 0.001 | 0.0000 | 0.010 | 0.00% |
| diethymeso-2,5- | 360.40 | 0.22 | 0.0006 | 1.00 | 0.02% |
| dibromoadipate | | | | | |
| Me-6TREN | 230.50 | 0.014 | 0.00006 | 0.100 | 0.00% |

The GPC scan with the reaction time was listed as follow:

| Rx IR Scan | Rx Time | GPC Mn |
|---|---|---|
| 97 | 0 | 0.000 |
| 401 | 2.53 | 88.739 |
| 762 | 5.53 | 105.821 |
| 1052 | 21.7 | 193.614 |
| 1082 | 27.1 | 217.315 |
| 1196 | 46.64 | 402.576 |

Synthesis of tert-polymer of 2-ethylhexyl acrylate n-butyl acrylate and 4-hydroxybutyl acrylate (NBJ408530).

The synthesis procedure was described with the feed ratio of:

| | MW | grams | Moles | Mole Ratio | Wt % |
|---|---|---|---|---|---|
| 2-ethylhexyl acrylate | 184.00 | 220.80 | 1.2000 | 2000.0 | 18.70% |
| 4-hydroxybutyl acrylate | 144.00 | 138.24 | 0.9600 | 1600.0 | 11.71% |
| n-butyl acrylate | 128.17 | 338.37 | 2.6400 | 4400.0 | 28.65% |
| Dimethyl sulfoxide | 78.13 | 355.2 | | | 30.08% |
| Ethyl Acetate | 88.11 | 128.1 | | | 10.85% |
| Copper (II) Bromide | 223.37 | 0.001 | 0.0000 | 0.010 | 0.00% |
| diethymeso-2,5- | 360.40 | 0.22 | 0.0006 | 1.00 | 0.02% |
| dibromoadipate | | | | | |
| Me-6TREN | 230.50 | 0.014 | 0.00006 | 0.100 | 0.00% |

GPC scan of MW vs. reaction time:

| Rx IR Scan | Rx Time | GPC Mn |
|---|---|---|
| 97 | 0 | 0.000 |
| 401 | 2.53 | 88.739 |
| 762 | 5.53 | 105.821 |
| 1052 | 21.7 | 193.614 |
| 1082 | 27.1 | 217.315 |
| 1196 | 46.64 | 402.576 |

Synthesis of tert-polymer of 2-ethylhexyl acrylate n-butyl acrylate and 4-hydroxybutyl acrylate (NBJ408534).

The synthesis procedure was described with the feed ratio of:

| | MW | grams | Moles | Mole Ratio | Wt % |
|---|---|---|---|---|---|
| 2-ethylhexyl acrylate | 184.00 | 750.72 | 4.0800 | 6800.0 | 54.07% |
| 4-hydroxybutyl acrylate | 128.17 | 30.76 | 0.2400 | 400.0 | 2.22% |
| n-butyl acrylate | 128.17 | 61.52 | 0.4800 | 800.0 | 4.43% |
| Dimethyl sulfoxide | 78.13 | 400.7 | | | 28.86% |
| Ethyl Acetate | 88.11 | 144.5 | | | 10.41% |
| Copper (II) Bromide | 223.37 | 0.001 | 0.0000 | 0.010 | 0.00% |
| diethymeso-2,5- | 360.40 | 0.22 | 0.0006 | 1.00 | 0.02% |
| dibromoadipate | | | | | |
| Me-6TREN | 230.50 | 0.014 | 0.00006 | 0.100 | 0.00% |

GPC scan vs reaction time

| Rx IR Scan | Rx Time | GPC Mn |
|---|---|---|
| 97 | 0 | 0.000 |
| 401 | 2.53 | 88.739 |
| 762 | 5.53 | 105.821 |
| 1052 | 21.7 | 193.614 |
| 1082 | 27.1 | 217.315 |
| 1196 | 46.64 | 402.576 |

### Formulation Testing

### Modulus

The Optically Clear Adhesive (OCA) formulations having the compositions described below were tested on an Anton Paar MCR 302 rheometer for both modulus and creep recovery. To establish good contact with the rheometer plates, the initially liquid test sample was photo-cured to form a 600-um film through the bottom quartz plate at 100 mW/cm2 of UVA for 90 seconds. The modulus measurement was generally conducted with a 8-mm aluminium parallel plate and a liquid nitrogen cooling unit from −25 to 25° C. at 0.1% strain, 1 Hz oscillation frequency, and zero normal force. A heating rate of 3° C./min of heating rate was originally used, then switched to 5° C./min.

The moduli of the formulations at −20 and 25° C., along with the Tg values are listed in Table 1 through 6. For consistent reporting and fast data analysis, an auto-analysis macro was set up using the Anton Paar RheoPlus software to determine the moduli in megapascal (MPa) at the temperatures of interest, as well as the Tg values. In this study, the temperature corresponding to the maximum of the tan(δ) peak was taken to be the Tg. If a tan(δ) peak was not fully captured in the temperature range studied, the Tg is considered lower than −25° C., and reported as “<−25” ° C. in the tables below.

### Creep Recovery

After the temperature sweep described above, the creep recovery test was performed on select formulations by straining the cured sample to 200% in 0.2 sec, allowing it to relax for 20 min at constant strain of 200%, and then monitoring the strain recovery after instantly removing all the accumulated shear stress. The strain at 2400 s of the test run was recorded, and the recovery calculated using the following equation:

$$Recovery = \frac{200 - Strain @ 2400 s}{200} * 100$$

The 70D formulation described below shows a remarkably higher creep recovery of 98%. At the same time, the formulation has a modulus of 0.18 MPa at −20° C., and a modulus of 0.02 MPa at 25° C.

Formulation
70D

| Ingredient | Weight (g) |
|---|---|
| SB407914 | 4.054 |
| IDA | 0.506 |
| Dodecyl VE | 2.006 |
| 4-HBA | 0.457 |
| 819 mix | 0.045 |
| | 7.068 |

### Temperature Sweep Results

TABLE 1
Run #1-10

| | G′ @ −20° C. | G′ @ 25° C. | T_{g} |
|---|---|---|---|
| Formulations | (MPa) | (MPa) | (° C.) |
| 62B | 21.08 | 0.07 | −11 |
| 62C | 4.35 | 0.04 | −15 |
| 62D | 15.80 | 0.06 | −11 |
| 63B | 1.74 | 0.04 | −18 |
| 63C | 1.09 | 0.03 | −18 |
| 63D | 1.49 | 0.05 | −20 |
| 64A | 2.07 | 0.03 | −18 |
| 64B | 3.58 | 0.04 | −16 |
| 65C | 3.12 | 0.10 | −20 |
| 65E | 82.83 | 0.10 | −6 |

TABLE 2
Run #11-20

| | G′ @ −20° C. | G′ @ 25° C. | T_{g} |
|---|---|---|---|
| Formulations | (MPa) | (MPa) | (° C.) |
| 66A | 43.84 | 0.08 | −10 |
| 66B | 29.98 | 0.05 | −10 |
| 66D | 1.46 | 0.05 | −22 |
| 66E | 1.23 | 0.04 | −22 |
| 67A | 1.02 | 0.05 | −24 |
| 67B | 0.64 | 0.03 | −23 |
| 67C | 4.20 | 0.11 | −21 |
| 67D | 4.82 | 0.09 | −19 |
| 68B | 66.9 | 0.11 | −5 |
| 69A | 0.89 | 0.04 | <−25 |

TABLE 3
Run #21-30

| | G′ @ −20° C. | G′ @ 25° C. | T_{g} |
|---|---|---|---|
| Formulations | (MPa) | (MPa) | (° C.) |
| 69B | 1.06 | 0.04 | −23 |
| 69C | 2.51 | 0.02 | −14 |
| 69D | 3.38 | 0.08 | −20 |
| 69E | 4.86 | 0.10 | −20 |
| 70A | 6.64 | 0.12 | −19 |
| 70B | 0.42 | 0.02 | <−25 |
| 70C | 0.53 | 0.02 | <−25 |
| 70D | 0.18 | 0.02 | <−25 |
| 71A | 0.19 | 0.02 | <−25 |
| 71B | 0.31 | 0.03 | <−25 |

TABLE 4
Run #31-40

| | G′ @ −20° C. | G′ @ 25° C. | T_{g} |
|---|---|---|---|
| Formulations | (MPa) | (MPa) | (° C.) |
| 71E | 0.01 | 0.004 | <−25 |
| 71E (dried) | 1.58 | 0.08 | <−25 |
| 71F | 0.97 | 0.04 | <−25 |
| 72A | 0.59 | 0.02 | <−25 |
| 72B | 6.27 | 0.09 | −18 |
| 72C | 7.13 | 0.08 | −18 |
| 73E | 0.73 | 0.09 | <−25 |
| 74B | 0.54 | 0.06 | <−25 |
| 74C | 0.67 | 0.05 | <−25 |
| 74D | 0.56 | 0.07 | <−25 |

TABLE 5
Run #41-50

| | G′ @ −20° C. | G′ @ 25° C. | T_{g} |
|---|---|---|---|
| Formulations | (MPa) | (MPa) | (° C.) |
| 75A | 1.35 | 0.09 | −16 |
| 75C | 0.67 | 0.04 | <−25 |
| 75D | 0.53 | 0.03 | <−25 |
| 75E | 1.28 | 0.06 | <−25 |
| 75F | 7.90 | 0.11 | −17 |
| 76A | 3.84 | 0.08 | −19 |
| 76B | 4.56 | 0.08 | −19 |
| 76C | 4.82 | 0.07 | −17 |
| 76D | 1.16 | 0.07 | <−25 |
| 76F | 0.72 | 0.06 | <−25 |

TABLE 6
Run #51-60

| | G′ @ −20° C. | G′ @ 25° C. | T_{g} |
|---|---|---|---|
| Formulations | (MPa) | (MPa) | (° C.) |
| 77A | 0.95 | 0.06 | <−25 |
| 77B | 4.29 | 0.08 | −18 |
| 77C | 1.93 | 0.03 | <−25 |
| 77D | 0.33 | 0.06 | <−25 |
| 77E | 0.26 | 0.04 | <−25 |
| 78A | 0.39 | 0.09 | <−25 |
| 78B | 0.44 | 0.05 | <−25 |
| 79F | 0.46 | 0.09 | <−25 |
| 80B | 0.10 | 0.0008 | <−25 |
| 80C | 0.13 | 0.003 | <−25 |

Applicant has surprisingly found that introducing a vinyl ether monomer into an acrylate system can significantly reduce the modulus and Tg of the resulting polymer, while simultaneously achieving a high creep recovery rate at very low modulus. This combination of physical properties of very low modulus at low temperature with very high creep recovery rate has never before been observed and is an unexpected result.

The formulations tested above have the following compositions:

| 62B | | 62C | | 62D | | 63B | |
|---|---|---|---|---|---|---|---|
| 58C | 6.492 | 58C | 5.853 | 58C | 5.139 | 53A | 8.119 |
| 58A | 0.662 | 58A | 0.607 | 62A | 1.045 | 58A | 0.828 |
| MBF | 0.359 | 184/819/MBF | 0.101 | 58A | 0.626 | mix | 0.107 |
| Sum | 7.513 | | 6.561 | 184/819/ | 0.467 | | 9.049 |
| | | | | MBF | 7.277 | | |
| 52C | | 63A | | 63C | | 63D | |
| 7929-19HNV | 33.619 | 7929-19HNV | 50.058 | 63A | 8.545 | 63A | 6.781 |
| 7929-50K | 6.983 | 7929-50K | 10.4 | 62A | 0.739 | 62A | 0.678 |
| 10AH-15X | 7.918 | 10AH-15X | 11.696 | mix | 0.105 | mix | 0.051 |
| IDA | 10.149 | IDA | 15.008 | 58A | 0.975 | | 7.51 |
| 4-HBA | 3.379 | 4-HBA | 5.112 | | 10.364 | | |
| I80A | 4.073 | | 92.274 | | | | |
| | 66.121 | | | | | | |
| 64A | | 64B | | 65C | | 65D | |
| 52A | 8.162 | PEM-X264 | 7.188 | SB407914 | 4.036 | SB407914 | 9.778 |
| 59E | 0.906 | 59E | 1.267 | IDA | 2.542 | 59E | 9.36 |
| mix | 0.083 | 2-BCA | 0.489 | 4-HBA | 0.456 | | 19.138 |
| | 9.151 | mix | 0.071 | mix | 0.08 | | |
| | | | 9.015 | | 7.114 | | |
| 65E | | 66A | | 66B | | 66D | |
| 65D | 5.392 | 65D | 6.749 | 65D | 5.277 | PEM-X264 | 6.464 |
| IDA | 0.494 | IDA | 1.706 | IDA | 1.96 | mix | 0.056 |
| 4-HBA | 0.643 | 4-HBA | 0.459 | 4-HBA | 0.494 | | 6.52 |
| mix | 0.067 | mix | 0.104 | mix | 0.233 | | |
| | 6.596 | | 9.018 | | 7.964 | | |
| 66E | | 67A | | 67B | | 67C | |
| PEM-X264 | 5.452 | PEM-X264 | 3.979 | PEM-X264 | 6.049 | MJ408642D | 7.151 |
| 4-HBA | 0.229 | JY220-083 | 0.828 | PIB DA | 0.393 | mix | 0.05 |
| mix | 0.056 | mix | 0.027 | 2-BCA | 0.063 | | 7.201 |
| | 5.737 | | 4.834 | mix | 0.027 | | |
| | | | | | 6.532 | | |

| 67D | | 68B | | 68D | | 69A | |
|---|---|---|---|---|---|---|---|
| MJ408642D | 6.378 | SB407914 | 3.441 | 7929-19HNV | 15.948 | PEM-X264 | 6.036 |
| 4-HBA | 0.303 | 59E | 3.297 | 7929-50K | 6.611 | 2-BCA | 0.065 |
| 2-BCA | 0.1 | CR551 | 0.624 | 4-HBA | 1.142 | Mix | 0.024 |
| mix | 0.051 | 4-HBA | 0.802 | | 23.701 | | 6.125 |
| | 6.832 | mix | 0.084 | | | | |
| | | | 8.248 | | | | |
| 69B | | 69C | | 69D | | 69E | |
| PEM-X264 | 5.305 | 68D | 6.66 | MJ408642 | 7.455 | MJ408642 | 9.855 |
| 2-BCA | 0.148 | 2-BCA | 0.116 | 2-BCA | 0.07 | 2-BCA | 0.301 |
| Mix | 0.026 | Mix | 0.023 | mix | 0.029 | mix | 0.042 |
| | 5.479 | | 6.799 | | 7.554 | | 10.198 |
| 70A | | 70B | | 70C | | | |
| MJ408642 | 6.931 | NBJ408535 | 6.605 | NBJ408535 | 6.004 | | |
| 2-BCA | 0.376 | 2-BCA | 0.193 | DMAA | 0.12 | | |
| mix | 0.035 | mix | 0.027 | mix | 0.037 | | |
| | 7.342 | | | | | | |
| 70D | | 71A | | 71B | | | |
| SB407914 | 4.054 | 70E | 7.132 | 70E | 5.072 | | |
| IDA | 0.506 | mix | 0.026 | 2-BCA | 0.022 | | |
| Dodecyl VE | 2.006 | | | mix | 0.106 | | |
| 4-HBA | 0.457 | | | | | | |
| mix | 0.045 | | | | | | |
| | 7.068 | | | | | | |
| 71E | | 71F | | 71G | | | |
| NBJ408536 | 6.554 | NBJ408537 | 7.717 | 52A | 5 | | |
| 2-BCA | 0.13 | 2-BCA | 0.217 | 59E | 0.515 | | |
| mix | 0.028 | mix | 0.063 | NBJ408534 | 61.058 | | |
| | | | | 0.073 | | | |
| 72A | | 72B | | 72C | | | |
| SB407914 | 3.417 | MJ408646D | 7.121 | MJ408645E | 7.766 | | |
| 59E | 3.365 | 2-BCA | 0.212 | 2-BCA | 0.249 | | |
| CM1007 | 2.14 | mix | 0.053 | mix | 0.053 | | |
| 4-HBA | 2.153 | | | | | | |
| IDA | 0.763 | | | | | | |
| mix | 0.122 | | | | | | |

| 72D | | 73B | | 73E | |
|---|---|---|---|---|---|
| NBJ408649 | 6.948 | MJ408646D | 6.726 | MJ408646D | 3.705 |
| 2-BCA | 0.19 | Dodecyl VE | 0.495 | NBJ408537 | 3.091 |
| mix | 0.056 | 2-BCA | 0.195 | 2-BCA | 0.22 |
| | | mix | 0.056 | mix | 0.05 |
| 73D | | 72E | | 73F | |
| MJ408646D | 3.705 | MJ408650E | 6.901 | MJ408650E | 6.075 |
| NBJ408537 | 2.184 | 2-BCA | 0.241 | 2-BCA | 0.223 |
| PIB DA | 1.094 | mix | 0.061 | mix | 0.052 |
| 2-BCA | 0.215 | | | dodecyl VE | 0.683 |
| mix | 0.05 | | | | |
| 74A | | 74B | | 74C | |
| MJ408650E | 6.043 | MJ408650E | 6.133 | MJ408646D | 6.101 |
| 2-BCA | 0.223 | 2-BCA | 0.222 | 2-BCA | 0.228 |
| mix | 0.039 | 15D | 0.053 | 15D | 0.045 |
| 2-EHA | 0.633 | 2-EH VA | 0.702 | dodecyl VE | 0.682 |
| | | | | Polycaprolactone | 0.729 |
| | | | | DMA | |
| 74D | | 75A | | 75B | |
| MJ408650E | 6.425 | MJ408650E | 5.872 | MJ408646D | 53.181 |
| 2-BCA | 0.291 | 2-BCA | 0.231 | 2-BCA | 1.435 |
| CM1007 | 0.737 | CD9075 | 0.697 | 15D | 0.404 |
| 15D | 0.052 | 15D | 0.051 | | |
| 76D | | 76F | | 77A | |
| MJ408661F | 5.801 | MJ408661F | 8.207 | SB407914 | 5.985 |
| 2-EHVE | 0.585 | 2-EHVE | 1.259 | Dodecyl VE | 0.62 |
| BCA | 0.202 | BCA | 0.334 | BCA | 0.193 |
| 15D | 0.059 | 15D | 0.086 | 15D | 0.068 |
| | | | | | 6.866 |
| 77B | | 77C | | | |
| MJ408646D | 5.88 | MJ408646D | 4.454 | | |
| 4-HB VE | 0.684 | Octyldecyl VE | 0.451 | | |
| BCA | 0.212 | BCA | 0.153 | | |
| 15D | 0.069 | 15D | 0.052 | | |

Although Applicant has provided descriptions and examples of various embodiments of the invention, the scope thereof is not to be limited to the specific embodiments but is defined only in the appended claims. Those of skill in the art would understand that various modifications to the embodiments of this disclosure may be made without departing from the spirit and scope of the present disclosure.

1. A method of making an adhesive composition comprising:
combining a polyurethane acrylate and a vinyl ether to form a mixture and co-curing the mixture to form the adhesive composition, wherein after curing the adhesive composition has a modulus of less than about 10.0 mPa at −20° C. and a creep recovery of greater than about 50%.

2. The method of claim 1, wherein the polyurethane acrylate is created by:
providing a highly branched diol; reacting the highly branched diol with a diisocyanate to obtain a polyurethane; and reacting the polyurethane with an acrylate to form a polyurethane acrylate.

3. The method of claim 2 wherein the highly branched diol is a polyfarnesene or a dimer acid polyester.

4. The method of claim 2, wherein the diol has a molecular weight of greater than about 1000 g/mol.

5. The method of claim 1, wherein the co-curing is done by light curing or heat curing.

6. The method of claim 1, wherein the diisocyanate is an aliphatic diisocyanate.

7. The method of claim 1, wherein the polyurethane acrylate is combined with vinyl ether in a molar ratio of vinyl ether to polyurethane acrylate of less than about 1.

8. The method of claim 1, wherein the polyurethane acrylate has a molecular weight of over about 25000 g/mol.

9. The method of claim 1, wherein the adhesive composition has a modulus of less than about 1.0 mPa at −20° C. and a creep recovery of greater than about 70%.

10. The method of claim 1, wherein the adhesive composition has a modulus of less than about 0.3 mPa at −20° C. and a creep recovery of greater than about 90%.

11. The method of claim 1, wherein the polyurethane acrylate has a glass transition temperature of less than 10° C.

12. The method of claim 1, wherein the polyurethane acrylate has a glass transition temperature of less than −30° C.

13. The method of claim 1, further comprising combining the polyurethane acrylate with a photoinitiator or a thermal initiator before the co-curing step.

14. The method of claim 1, wherein the vinyl ether is a member selected from poly(butyl vinyl ether), poly(ethyl vinyl ether), poly(hexyl vinyl ether), poly(isobutyl vinyl ether), poly(isopropyl vinyl ether), poly(methyl vinyl ether), poly(octyl vinyl ether), poly(propyl vinyl ether), and combinations thereof.

15. The method of claim 1, wherein the polyurethane acrylate is selected from poly(2-ethylhexyl acrylate), poly(2,2,3,3,-tetrafluoropropyl acrylate), poly(4-cyanobutyl acrylate), poly(butyl acrylate), poly(dodecyl acrylate), poly(ethyl acrylate), poly(hexyl acrylate), poly(isobutyl acrylate), poly (isopropyl acrylate), poly (nonyl acrylate), poly(propyl acrylate), poly(sec-butyl acrylate), poly (tetrahydrofurfural acrylate), poly decyl methacrylate), poly(dodecyl methacrylate), poly(hexyl methacrylate), poly(isodecyl methacrylate), poly(octyl methacrylate), and combinations thereof.

16. An adhesive composition comprising a co-cured mixture of polyurethane acrylate and vinyl ether, wherein the adhesive composition has a modulus of less than about 10.0 mPa at −20° C. and a creep recovery of greater than about 50%.

17. The adhesive composition of claim 16, wherein the adhesive composition has a modulus of less than about 1.0 mPa at −20° C. and a creep recovery of greater than about 70%.

18. The adhesive composition of claim 16, wherein the adhesive composition has a modulus at −20° C. of less than about 0.3 mPa and a creep recovery of greater than about 90%.

19. The adhesive composition of claim 16, wherein the molar ratio of the vinyl ether to the acrylic monomer is equal to or less than about 1.

20. The adhesive composition of claim 16, wherein there is no solvent present in the composition.

21. The adhesive composition of claim 16, wherein the composition further comprises a thermal initiator or a photoinitiator.

22. The adhesive composition of claim 16, wherein the vinyl ether is a member selected from poly(butyl vinyl ether), poly(ethyl vinyl ether), poly(hexyl vinyl ether), poly(isobutyl vinyl ether), poly(isopropyl vinyl ether), poly(methyl vinyl ether), poly(octyl vinyl ether), poly(propyl vinyl ether), and combinations thereof.

23. The adhesive composition of claim 16, wherein the polyurethane acrylate is selected from poly(2-ethylhexyl acrylate), poly(2,2,3,3,-tetrafluoropropyl acrylate), poly(4-cyanobutyl acrylate), poly(butyl acrylate), poly(dodecyl acrylate), poly(ethyl acrylate), poly(hexyl acrylate), poly(isobutyl acrylate), poly (isopropyl acrylate), poly (nonyl acrylate), poly(propyl acrylate), poly(sec-butyl acrylate), poly (tetrahydrofurfural acrylate), poly decyl methacrylate), poly(dodecyl methacrylate), poly(hexyl methacrylate), poly(isodecyl methacrylate), poly(octyl methacrylate), and combinations thereof.
